(19) United States
(12) Patent Application Publication
(10) Pub. No.: US 2026/0339290 A1
(43) Pub. Date: Oct. 29, 2026

(54) SYSTEM AND METHOD FOR GENERATIVE ARTIFICIAL INTELLIGENCE-ASSISTED AUTONOMOUS THERMAL ANOMALY DETECTION OF OIL AND GAS PROCESS EQUIPMENT

(71) Applicant: Schlumberger Technology Corporation, Sugar Land, TX (US)

(72) Inventors: Fei Song, Houston, TX (US); Juan Alvarez, Houston, TX (US); Christopher Jinks, Delhi, LA (US); Edward Gutierrez, Jr., Houston, TX (US); Judy Zhuqing Dong, Houston, TX (US)

(21) Appl. No.: 19/193,507

(22) Filed: Apr. 29, 2025

(51) Int. Cl. G05B 19/4065

(52) U.S. Cl. CPC G05B 19/4065; G05B 2219/49219

(57) ABSTRACT

A method operable to automatically detect a thermal anomaly in equipment. The method includes segmenting the equipment based on visual information about components of the equipment and a thermal image of the equipment, the visual information and the thermal image being used as prompts to a first generative artificial intelligence model, the first generative artificial intelligence model providing a segmentation of the equipment into the components. The method also includes determining a temperature of each of the components based on results from the segmentation and a temperature data field of the equipment. The method also includes determining temperature thresholds for the components of the equipment, and triggering an action when the temperature of one of the components exceeds a temperature threshold associated with the one of the components.

### BACKGROUND

Oil and gas process equipment may include, but is not limited to, pumps, motors, bearings, compressors, tanks, heat exchangers, dehydrators, membranes, separators, valves, electrical connections, breakers, and fuses. The equipment may also include machines and systems used to extract, process, and transport oil and gas. Temperature is one of the most common indicators of the structural health of some process equipment and components. Faulty machinery may result in abnormal temperature distribution in the components. Infrared thermography is a condition monitoring tool in which the temperature may be measured in a real-time in a non-contact manner. Infrared thermography may enable detection of equipment flaws and faulty industrial processes under operating conditions, thereby reducing production downtime, catastrophic breakdown and maintenance costs. For various reasons, it is desirable to limit the human physical presence and intervention in industrial process plants, and inspection and maintenance operations should ideally be converted to condition-based predictions to reduce the overall in-operation failure rate. Autonomous robotics may be used to handle as many tasks as possible. The emerging technologies of artificial intelligence (AI), machine learning (ML), particularly generative artificial intelligence (GenAI) may be used to automatically detect process equipment malfunctions with thermal images. These technologies may assist and automate visual inspection, increase safety, reduce access costs, provide objective classification, and facilitate integration with digital asset management systems.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method operable to automatically detect a thermal anomaly in equipment. The method includes segmenting the equipment based on visual information about components of the equipment and a thermal image of the equipment, the visual information and the thermal image being used as prompts to a first generative artificial intelligence model, the first generative artificial intelligence model providing a segmentation of the equipment into the components. The method also includes determining a temperature of each of the components based on results from the segmentation and a temperature data field of the equipment. The method also includes determining temperature thresholds for the components of the equipment, and triggering an action when the temperature of one of the components exceeds a temperature threshold associated with the one of the components. Other embodiments of this aspect include corresponding computer systems, apparatus, and computer programs recorded on one or more computer storage devices, each configured to perform the actions of the methods.

One general aspect includes a computing system. The computing system includes one or more processors, and a memory system that may include one or more non-transitory computer-readable media storing instructions that, when executed by at least one of the one or more processors, cause the computing system to perform operations operable to automatically detect a thermal anomaly in equipment. The operations may include segmenting the equipment based on visual information about components of the equipment and a thermal image of the equipment, the visual information and the thermal image being used as prompts to a first generative artificial intelligence model, the first generative artificial intelligence model providing a segmentation of the equipment into the components, determining a temperature of each of the components based on results from the segmentation and a temperature data field of the equipment, determining temperature thresholds for the components of the equipment, and triggering an action when the temperature of one of the components exceeds a temperature threshold associated with the one of the components. Other embodiments of this aspect include corresponding computer systems, apparatus, and computer programs recorded on one or more computer storage devices, each configured to perform the actions of the methods.

One general aspect includes a non-transitory computer-readable medium storing instructions that, when executed by one or more processors of a computing system, cause the computing system to perform operations operable to automatically detect a thermal anomaly in equipment. The operations include segmenting the equipment based on visual information about components of the equipment and a thermal image of the equipment, the visual information and the thermal image being used as prompts to a first generative artificial intelligence model, the first generative artificial intelligence model providing a segmentation of the equipment into the components. The operations also include determining a temperature of each of the components based on results from the segmentation and a temperature data field of the equipment. The operations also include determining temperature thresholds for the components of the equipment, and triggering an action when the temperature of one of the components exceeds a temperature threshold associated with the one of the components. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, in accordance with embodiments of the present disclosure.

FIG. 2 is a block diagram of a system for using generative AI to automate thermal anomaly detection for oil and gas process equipment in accordance with embodiments of the present disclosure.

FIG. 3 is an illustration of a use case example of a hot oil pump seal leak feature.

FIG. 4 is an image of machine learning-based object detector output of bounding boxes to be used as input prompt.

FIG. 5 is an image of automatic generation of segmentation of hot oil pump bearing of interest with masks on the thermal image without requiring additional training in accordance with embodiments of the present disclosure.

FIG. 6 is an illustration of temperature extraction at hot oil pump bearing of interest.

FIGS. 7A and 7B are illustrations of comparisons of maximum temperature rating allowed at bearing obtained from GenAI model ChatGPT (FIG. 7A), and manual search in the pump manufacture datasheet (FIG. 7B).

FIG. 8 is an illustration of autonomous thermal anomaly detection results for a hot oil pump in accordance with embodiments of the present disclosure.

FIGS. 9A and 9B are illustrations of thermal imaging in normal and abnormal situations as shown graphically in FIG. 8.

FIG. 10 is a flowchart of a method in accordance with embodiments of the present disclosure.

FIG. 11 illustrates a schematic view of a computing system for performing at least a portion of a method in accordance with embodiments of the present disclosure.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Systems and methods in accordance with embodiments of the present disclosure perform acoustic anomaly detection of oil and gas process equipment using psychoacoustics features-based machine learning. In some configurations, systems and methods in accordance with embodiments of the present disclosure may be developed as a model, and may be applied to, for example, hot oil pumps and other oil and gas process equipment, such as cooling fans, motors, membrane separators, valves, compressors, heat exchange, and pipeline gas leakage that could generate abnormal noise.

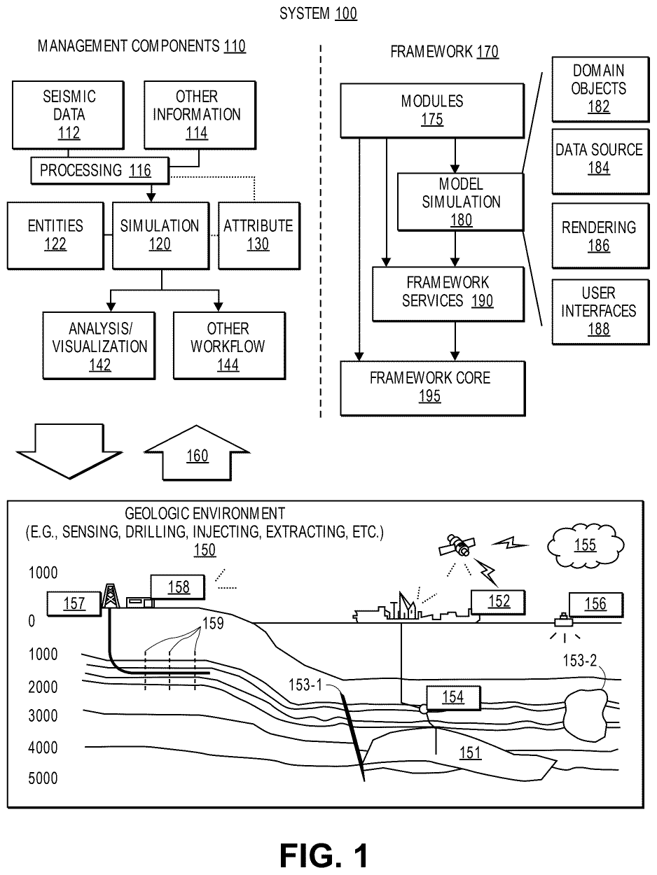

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages . NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement may include use of feedback loops executed on an algorithmic basis, such as at a computing device (e.g., computing system 100, FIG. 1), and/or through manual control by a user who may make determinations regarding whether a given step, action, template, or model has become sufficiently accurate.

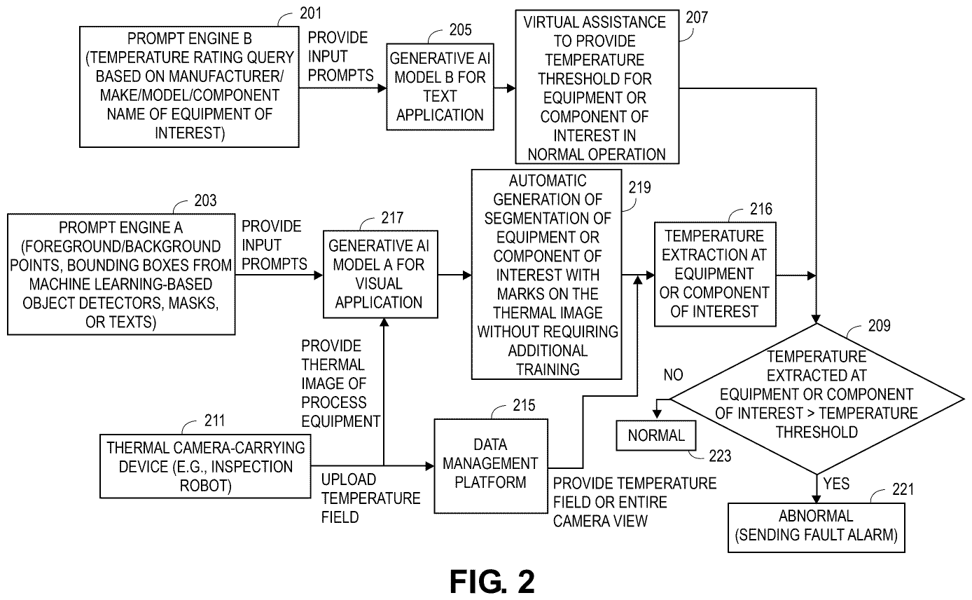

FIG. 2 illustrates the workflow for a system and method to automate thermal anomaly detection for oil and gas process equipment by leveraging machine learning for computer vision and GenAI visual and text applications in accordance with embodiments of the present disclosure. The system includes a thermal camera-carrying device 211 such as, for example, but not limited to, an inspection robot. The system may further include a data management platform 215 such as, for example, but not limited to, COGNITE DATA FUSION®. The system includes prompt engine A 203 and prompt engine B 201, GenAI model A 217 and GenAI model B 205. GenAI model A 217 may include, but is not limited to including, the Segment Anything model developed by Metal AI. GenAI model B 205 may include, but is not limited to including, the ChatGPT model developed by OpenAI. The models and the prompt engines may be hosted in cloud-based software.

The thermal camera-carrying device 211 may collect the thermal image that includes the process equipment, and may upload the temperature field in the text format into the data management platform, which stores and transmits the temperature field data, for example, in text format. The temperature field for the camera view provided by the data management platform 215 to temperature extraction at equipment or component of interest 216 may be described by the following mapping with the function ƒ(·)

ƒ(x, y)=T (1)

where (x, y) denotes the coordinates of the pixel within the thermal image shown along the horizonal and vertical directions, respectively, and T denotes the corresponding temperature value at the pixel location (x, y).

Prompt engine A 203 includes foreground/background points, bounding boxes from machine learning-based object detectors, masks, and/or texts. Prompt B 201 includes a query of the temperature rating for the equipment and/or component of interest by providing, for example, but not limited to, its manufacturer, make, model, and/or component name. GenAI model A 217 may automatically generate 219 segmentation of equipment and/or component of interest, with masks on the thermal image, without requiring additional training, and further extract 216 the temperature at the equipment and/or component of interest together with the temperature field data. The segmentation mask that is output from the GenAI model A 217 for visual application without requiring additional training can be described by Eq. (2). Mathematically, the segmentation mask can be represented as a function that maps each pixel location within the thermal image to either 0 (background) or 1 (equipment or component of interest).

S(x, y)={1, if pixel (x, y) belongs ¿ the equipment ∨ component of interest; 0, otherwise} (2)

where S(x, y) is the segmentation mask value at the pixel location (x, y), x is the horizontal coordinate of the pixel, and y is the vertical coordinate of the pixel within the thermal image. By combining Eqs. (1) and (2), the temperature values at the equipment or component of interest can be extracted.

GenAI model B 205 may be used for a text application 207. Design data sheets and operation manuals that contain instructions for the equipment of interest may be used to fine tune the GenAI model B 205 and adapt the GenAI model B 205 to a specific domain, for example, but not limited to, oil and gas process equipment, as needed. The GenAI model B 205 for domain-specific text applications may provide virtual assistance to respond with the temperature threshold for the equipment and/or component of interest in the normal operation. If 209 the temperature extracted at the equipment and/or component of interest exceeds the temperature threshold in the normal operation 223, an abnormal condition is flagged 221, and a fault alarm is sent, and/or other action is taken.

In prompt engine A 203, point prompts, for example, foreground and background points, may be obtained from machine learning-based keypoint detectors, and box prompts, for example, bounding boxes, may be obtained from machine learning-based object detectors. Mask prompts may be obtained from machine learning-based segmentation models. Machine learning-based keypoint detectors may include, but are not limited to including, deep neutral networks such as CenterNet, and you only look once (YOLO). Machine learning-based object detectors may include, but are not limited to including, deep neutral networks such as R-CNN, Fast R-CNN, Faster R-CNN, Single Shot MultiBox Detector, YOLO, RetinaNet, EfficientDet, and CenterNet. Machine learning-based segmentation models may include, but are not limited to including, deep neutral networks such as Mask R-CNN that may provide initial masks that roughly outline the object. Machine learning-based object detectors, machine learning-based keypoint detectors, and/or machine learning-based segmentation models may be obtained by training from scratch, transfer learning, and/or fine tuning pretrained deep neural networks on a custom image dataset of process equipment. GenAI model A 217 may include, but is not limited to including, any computer foundation model such as, for example, but not limited to, zero-shot vision models for generating promptable image masks such as, for example, but not limited to, the Segment Anything model or the Segment Anything Model 2, CLIPSeg model, and YOLOE. GenAI model B 205 for text-based visual assistance may include, but is not limited to including, large language models (LLMs) such as ChatGPT, and Llama, which may be trained to follow an instruction in a prompt and provide a detailed response.

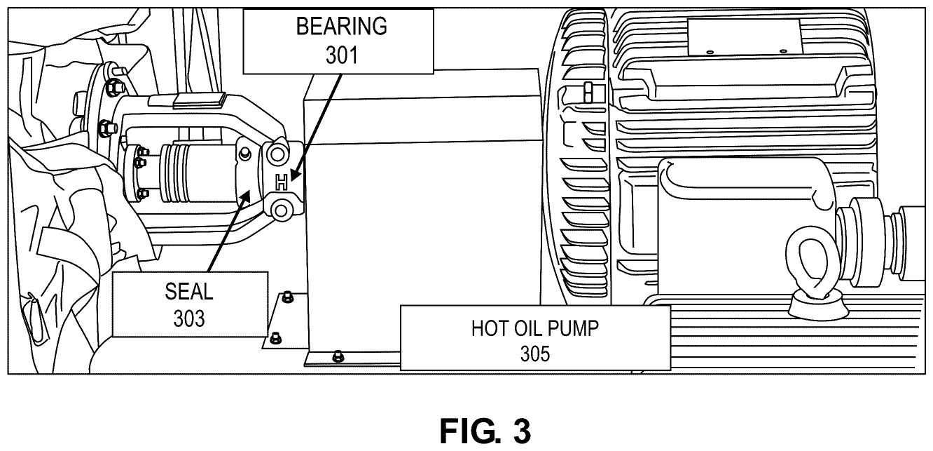

FIG. 3 illustrates a hot oil pump 305 in which the motor is driving the shaft, and the motor shaft is coupled with the pump shaft inside a cover. The temperature at the bearing area 301 may be monitored. On the left of the hot oil pump 305 is a seal 303 designed to prevent the hot oil from getting into the bearing 301. However, if leaks in the seal 303 occur, increased temperature may be expected at the bearing 301 due to the entered hot oil, and eventually the hot oil pump 305 will have to be shut down for repair.

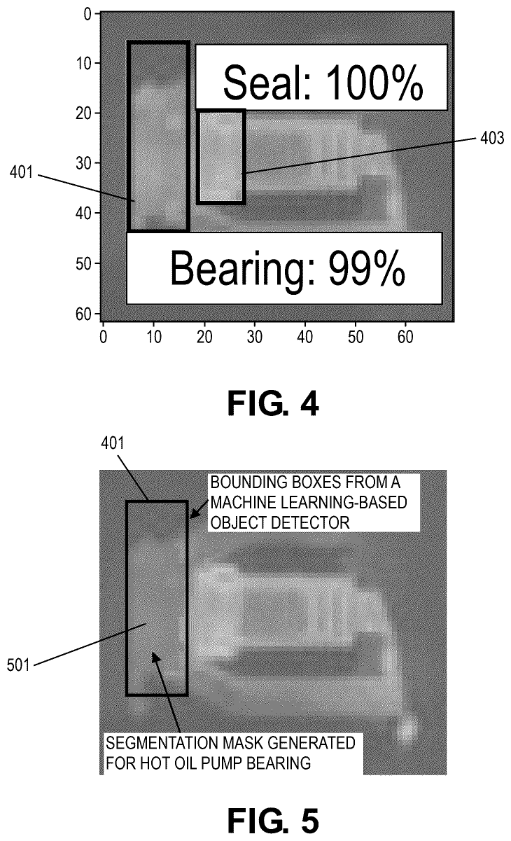

FIG. 4 illustrates an image of the output of the machine learning-based object detector, i.e., the bounding box 401 for the bearing and the seal bounding box 403 that may be further used as the input prompt. The percentage values shown in the bounding boxes obtained from the machine learning-based object detector represent the confidence score of the prediction from the object detection model. This confidence score suggests how certain the object detector is that the object within the box belongs to the predicted category or class. For example, the percentage “100%” denotes the object detector is 100% confident that the detected object in the box is indeed a seal, and the percentage “99%” denotes the object detector is 99% confident that the detected object in the box is indeed a bearing.

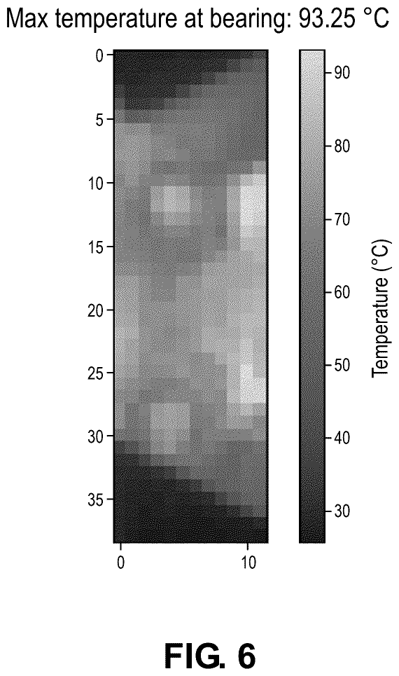

FIG. 5 illustrates an image showing the automatic generation of a segmentation mask 501 of the hot oil pump bearing (overlain on the bearing bounding box 401) with masks on the thermal image without requiring additional training. The bounding box 401 for the bearing serves as the prompt for GenAI model A 217 for visual application. The segmentation mask 501 is the output from GenAI model A 217 without requiring additional training. The segmentation mask 501 highlights which pixels in the image of temperature belong to the bearing by outlining the exact shape and location of the bearing at the pixel level.

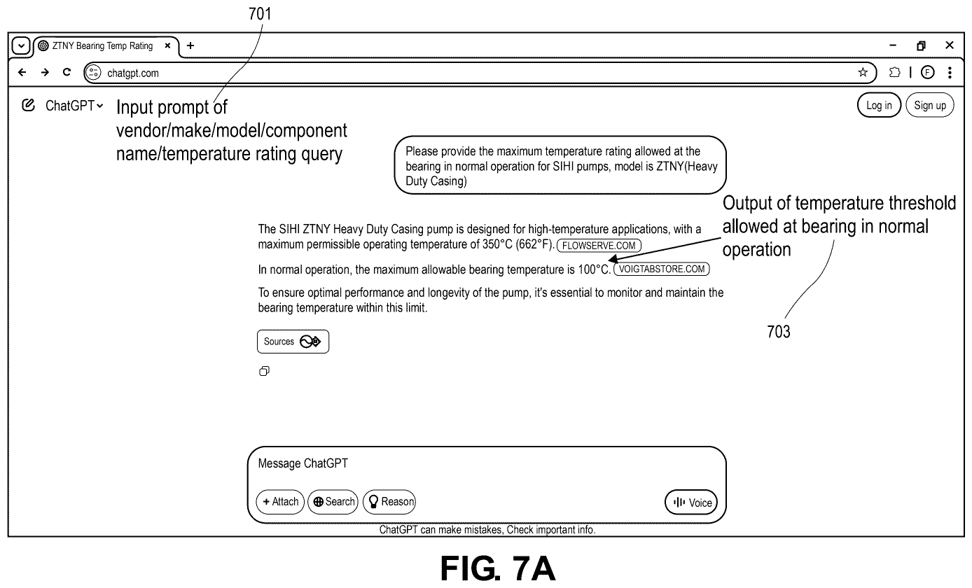

FIG. 6 shows the temperature extracted at a hot oil pump bearing of interest, where the maximum temperature at the bearing is 93.25 °C in this example. The region to extract the temperature at a hot oil pump bearing of interest is obtained from the automatically generated segmentation mask shown in FIG. 5. The horizontal and vertical axes define the positions of the pixels within the image shown along the horizonal and vertical directions, respectively, where pairs of the numbers in the axes may specify a point's location within the image relative to the axes.

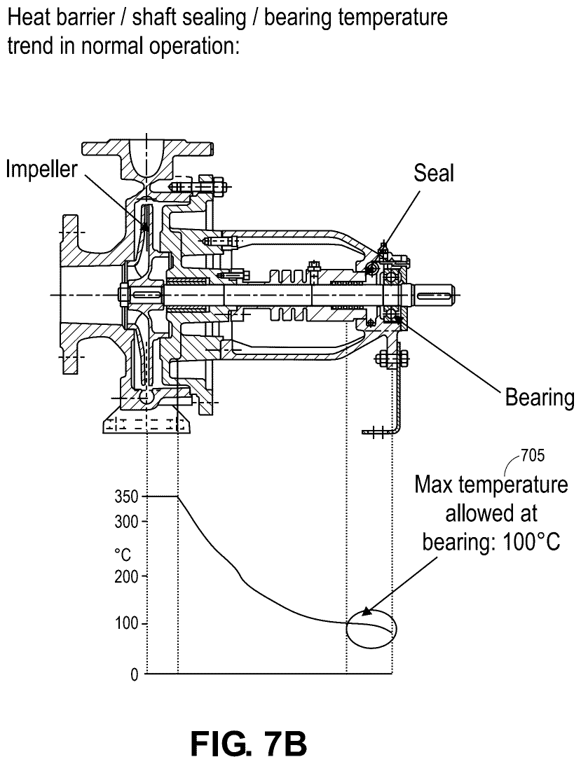

FIGS. 7A and 7B show the comparison of the maximum temperature rating allowed at the bearing obtained from the GenAI model B 205 (FIG. 2), and through manual search in the datasheet of the pump provided by the manufacturer. FIG. 7A shows the output 703 of the GenAI model B 205 (FIG. 2) with the input prompt 701 of querying the maximum temperature rating of the bearing in the normal operation by providing the manufacturer, make, and model of the hot oil pump. Based on the GenAI model B 205 (FIG. 2), the temperature threshold for the bearing in order to have the hot oil pump operate normally is automatically obtained as 100 °C. As a validation, the chart in FIG. 7B shows the maximum temperature allowed 705 at different locations of the pump through manually searching the technical datasheet from the manufacture. The maximum operating temperature allowed at the impeller is 350 °C. Because there is a heat barrier placed just after the impeller, the temperature is expected to drop from the impeller to the seal in normal operation. In order to operate normally, the seal and bearing are designed to take only 100 °C temperature. Therefore, the maximum allowed temperature at the bearing of the hot oil pump obtained from the GenAI model B 205 (FIG. 2) agrees favorably with that obtained by manually searching the datasheet of the pump.

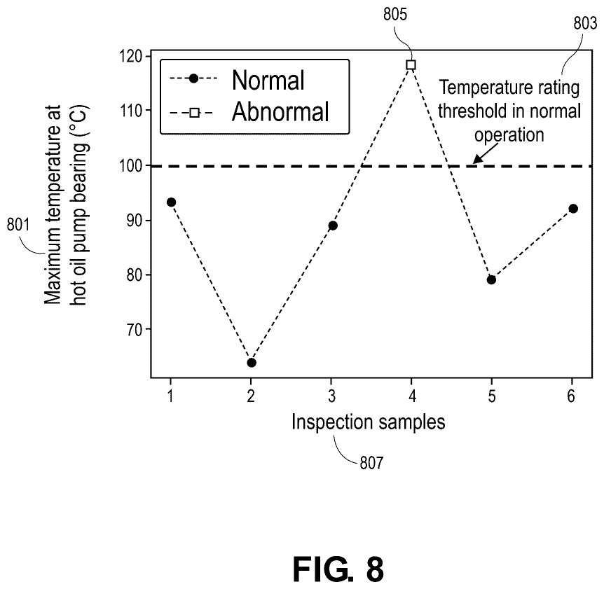

FIG. 8 illustrates the results of autonomously monitoring the maximum temperature 801 at the bearing of the same hot oil pump over time for thermal anomaly detection. The maximum temperature 803 allowed at the bearing obtained from the GenAI model B 205 (FIG. 2) is used as the temperature threshold to flag a thermal anomaly using an inspection robot. The maximum temperature at the bearing for the inspection sample #4 805 exceeds the temperature threshold 803 100 °C, which is therefore detected as anomaly, where the rest of the samples 807 are considered normal condition because their maximum temperature at the bearing is below the threshold 100 °C. In the case of the anomaly, the seal failed, and hot oil entered the bearing zone. In this case, the action triggered by the monitoring of the hot oil pump was to replace the seal and bearing.

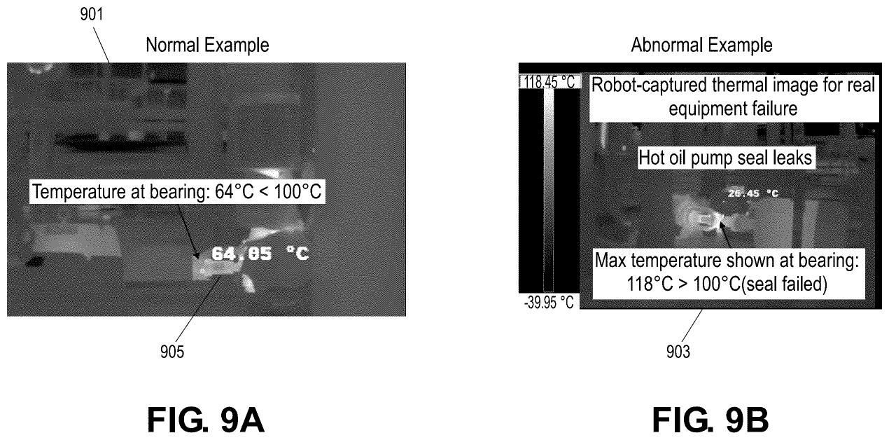

FIG. 9A illustrates a “normal” situation 901 in which the operating temperature at a bearing 905 is less than the threshold temperature for that bearing. FIG. 9B illustrates the “abnormal” situation 903 in which a thermal image of an equipment failure has been captured. In this case, a hot oil pump seal has leaked, raising the temperature of the bearing to above the threshold temperature for the bearing, in which case an alert is raised in accordance with embodiments of the present disclosure.

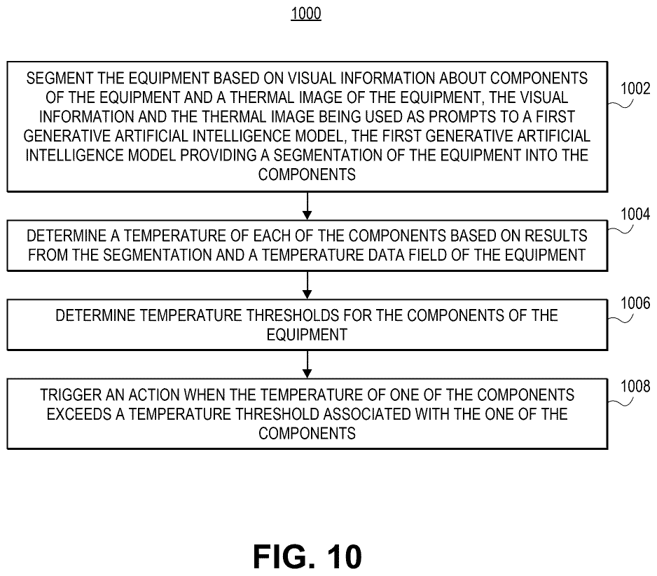

FIG. 10 is a flowchart of a method 1000 operable to automatically detect a thermal anomaly in equipment. The method 1000 may include, but is not limited to including, segmenting 1002 the equipment based on visual information about components of the equipment and a thermal image of the equipment. A first prompt engine provides the visual information, the first prompt engine may provide a first prompt. The thermal image and the temperature data field may be provided by a thermal camera-carrying device. A first generative artificial intelligence model segments the equipment based at least on the first prompt. The first prompt may include foreground/background points of the equipment, bounding boxes from an object detector, masks, and/or texts. The first generative artificial intelligence model may include a Segment Anything model, a Segment Anything Model 2, a CLIPSeg model, and/or a YOLOE model. The equipment may include oil and gas processing equipment.

The method 1000 may include determining 1004 a temperature of the components based on the segmentation and a temperature data field of the equipment. Segmentation of the equipment results in determining components. The temperature data field provides the temperature of each of the components.

The method 1000 may include determining 1006 temperature thresholds for the components of the equipment. A second prompt engine provides specification information about the equipment, the second prompt engine may provide a second prompt. A second generative artificial intelligence model may provide one of the temperature thresholds for a pre-selected component of the equipment based on the second prompt. The second prompt may include a temperature rating query based on a manufacturer of the equipment, and a make/model/component name of the equipment. The second generative artificial intelligence model may include a ChatGPT model, a Gemini model, a Copilot model, a Llama model, a T5 model, and a BERT model. The method 1000 may also include displaying the current temperature of the components of the equipment as determined by the temperature field, and the temperature threshold of the equipment as determined by the results from the second prompt.

The method 1000 may include triggering 1008 an action when the temperature of a pre-selected component of the components exceeds the temperature threshold. The action may include generating an abnormal fault alarm (e.g., including a display of the temperature of the component and the temperature threshold), and/or scheduling or performing a repair or replacement of the pre-selected component.

In another embodiment, the action may be or include generating and/or transmitting a signal (e.g., using a computing system) that recommends, instructs, or causes a physical action to occur at a wellsite. The action may also or instead include performing the physical action at the wellsite. The physical action may include monitoring equipment, power cycling equipment, notifying maintenance personnel of equipment failure, logging equipment behavior anomalies, or the like.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

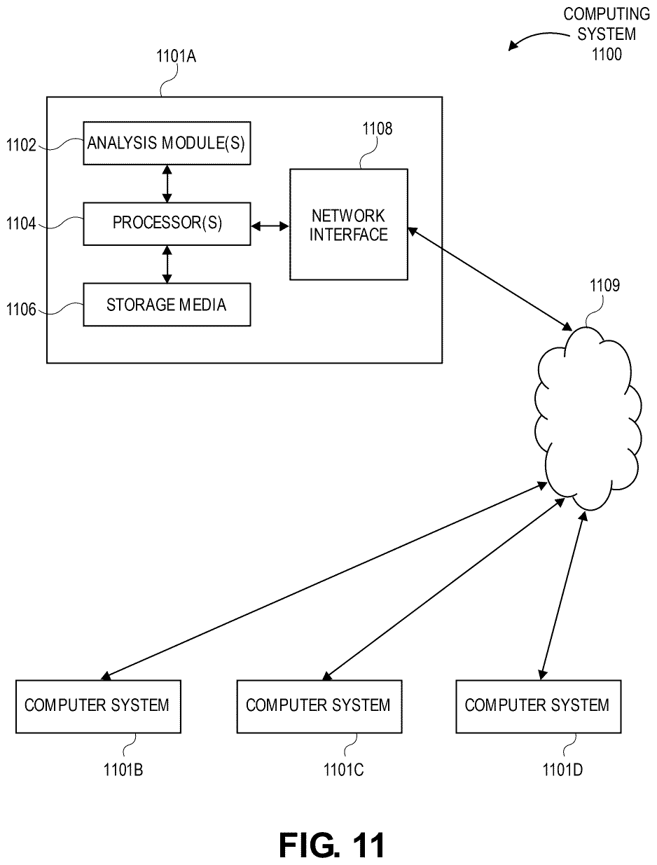

In some embodiments, the methods of the present disclosure may be executed by a computing system. FIG. 11 illustrates an example of such a computing system 1100, in accordance with some embodiments. The computing system 1100 may include a computer or computer system 1101A, which may be an individual computer system 1101A or an arrangement of distributed computer systems. The computer system 1101A includes one or more analysis modules 1102 that are configured to perform various tasks according to some embodiments, such as one or more methods disclosed herein. To perform these various tasks, the analysis module 1102 executes independently, or in coordination with, one or more processors 1104, which is (or are) connected to one or more storage media 1106. The processor(s) 1104 is (or are) also connected to a network interface 1108 to allow the computer system 1101A to communicate over a data network 1109 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101C and/or 1101D that are located in one or more data centers, and/or located in varying countries on different continents).

Continuing to refer to FIG. 11, a processor may include a microprocessor, microcontroller, processor module or subsystem, programmable integrated circuit, programmable gate array, or another control or computing device.

Continuing to refer to FIG. 11, the storage media 1106 may be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

Continuing to refer to FIG. 11, in some embodiments, computing system 1100 contains one or more time-lapse seismic module(s) 1108. It should be appreciated that computing system 1100 is merely one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1100, FIG. 11), and/or through manual control by a user who may make determinations regarding whether a given step, action, template, model, or set of curves has become sufficiently accurate for the evaluation of the subsurface three-dimensional geologic formation under consideration.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein may be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that may be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms.

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

1. A method operable to automatically detect a thermal anomaly in equipment, the method comprising:
segmenting the equipment based on visual information about components of the equipment and a thermal image of the equipment, the visual information and the thermal image being used as prompts to a first generative artificial intelligence model, the first generative artificial intelligence model providing a segmentation of the equipment into the components;
determining a temperature of each of the components based on results from the segmentation and a temperature data field of the equipment;
determining temperature thresholds for the components of the equipment; and
triggering an action when the temperature of one of the components exceeds a temperature threshold associated with the one of the components.

2. The method of claim 1, wherein
a first prompt engine provides the visual information and a first prompt,
the thermal image and the temperature data field are provided by a thermal camera-carrying device,
the first generative artificial intelligence model segments the equipment based at least on the first prompt,
a second prompt engine provides specification information about the equipment and provides a second prompt, and
a second generative artificial intelligence model provides one of the temperature thresholds for one of the components of the equipment based on the second prompt.

3. The method of claim 2, wherein the first prompt comprises:
foreground and background points of the equipment;
bounding boxes from an object detector;
masks; and
texts.

4. The method of claim 2, wherein the second prompt comprises:
a temperature rating query based on a manufacturer of the equipment; and
a make and model of the equipment and component names of the components.

5. The method of claim 1, wherein the temperature data field comprises:
temperature values of pixels within the thermal image.

6. The method of claim 1, wherein the segmentation comprises:
a function that maps coordinates of a pixel within the thermal image to either a background value or an equipment or component of interest value.

7. The method of claim 1, wherein the action comprises:
generating an abnormal fault alarm; and
scheduling a repair of the one of the components that exceeds the temperature threshold associated with the one of the components.

8. The method of claim 1, wherein the equipment comprises:
oil and gas processing equipment.

9. A computing system, comprising:
one or more processors; and
a memory system comprising one or more non-transitory computer-readable media storing instructions that, when executed by at least one of the one or more processors, cause the computing system to perform operations operable to automatically detect a thermal anomaly in equipment, the operations comprising:
segmenting the equipment based on visual information about components of the equipment and a thermal image of the equipment, the visual information and the thermal image being used as prompts to a first generative artificial intelligence model, the first generative artificial intelligence model providing a segmentation of the equipment into the components;
determining a temperature of each of the components based on results from the segmentation and a temperature data field of the equipment;
determining temperature thresholds for the components of the equipment; and
triggering an action when the temperature of one of the components exceeds a temperature threshold associated with the one of the components.

10. The computing system of claim 9, wherein
a first prompt engine provides the visual information and a first prompt,
the thermal image and the temperature data field are provided by a thermal camera-carrying device,
the first generative artificial intelligence model segments the equipment based at least on the first prompt,
a second prompt engine provides specification information about the equipment and provides a second prompt, and
a second generative artificial intelligence model provides one of the temperature thresholds for one of the components of the equipment based on the second prompt.

11. The computing system of claim 10, wherein the first prompt comprises:
foreground and background points of the equipment;
bounding boxes from an object detector;
masks; and
texts.

12. The computing system of claim 10, wherein the second prompt comprises:
a temperature rating query based on a manufacturer of the equipment; and
a make and model of the equipment and component names of the components.

13. The computing system of claim 9, wherein the temperature data field comprises:
temperature values of pixels within the thermal image.

14. The computing system of claim 9, wherein the segmentation comprises:
a function that maps coordinates of a pixel within the thermal image to either a background value or an equipment or component of interest value.

15. The computing system of claim 9, wherein the action comprises:
generating an abnormal fault alarm; and
scheduling a repair of the one of the components that exceeds the temperature threshold associated with the one of the components.

16. The computing system of claim 9, wherein the equipment comprises:
oil and gas processing equipment.

17. A non-transitory computer-readable medium storing instructions that, when executed by one or more processors of a computing system, cause the computing system to perform operations operable to automatically detect a thermal anomaly in equipment, the operations comprising:
segmenting the equipment based on visual information about components of the equipment and a thermal image of the equipment, the visual information and the thermal image being used as prompts to a first generative artificial intelligence model, the first generative artificial intelligence model providing a segmentation of the equipment into the components;
determining a temperature of each of the components based on results from the segmentation and a temperature data field of the equipment;
determining temperature thresholds for the components of the equipment; and
triggering an action when the temperature of one of the components exceeds a temperature threshold associated with the one of the components.

18. The non-transitory computer-readable medium of claim 17, wherein
a first prompt engine provides the visual information and a first prompt,
the thermal image and the temperature data field are provided by a thermal camera-carrying device,
the first generative artificial intelligence model segments the equipment based at least on the first prompt,
a second prompt engine provides specification information about the equipment and provides a second prompt, and
a second generative artificial intelligence model provides one of the temperature thresholds for one of the components of the equipment based on the second prompt.

19. The non-transitory computer-readable medium of claim 18, wherein the first prompt comprises:
foreground and background points of the equipment;
bounding boxes from an object detector;
masks; and
texts.

20. The non-transitory computer-readable medium of claim 18, wherein the second prompt comprises:
a temperature rating query based on a manufacturer of the equipment; and
a make and model of the equipment and component names of the components.
